(19) United States
(12) Patent Application Publication
(10) Pub. No.: US 2009/0068372 A1
(43) Pub. Date: Mar. 12, 2009

(54) DIPPING TANK FOR SEALING ARTICLES WITH WAX

(76) Inventor: Robert Irving, Pacifica, CA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/851,709

(22) Filed: Sep. 7, 2007

(51) Int. Cl. B05D 1/18; B05C 3/00

(52) U.S. Cl. 427/430.1; 118/423; 118/58

(57) ABSTRACT

An apparatus for applying a wax seal to an article such as a wine bottle including a bottom tank formed of at least one upstanding wall and a bottom wall and having an open top end, the bottom tank being fitted with electrical heating means; an upper tank formed of at least one upstanding wall and having an open top end and a closed bottom wall, the upper tank being fitted with electrical heating means, the upper tank being connected at its closed bottom wall with the open top end of said bottom tank, a screen adjustably located inside the upper tank, a pump located in the bottom tank and extending into the upper tank for conveying molten wax from the bottom tank to the upper tank and an overflow opening in the upper tank.

The present invention relates to a dipping tank apparatus which functions as a reservoir for sealing wax and contains heating means for heating the wax to melt the wax and for maintaining the wax in a molten condition to enable the application of the sealing wax to any desired article. In a further aspect of the present invention, there is provided a dipping tank apparatus for the dipping of bottles such as beverage bottles, especially wine bottles, into sealing wax to form a wax seal on the top or neck of the bottle. Dipping of bottles into sealing wax and forming a wax seal accomplishes a distinctive look on the wax sealed bottle and provides a positive seal. In addition, the wax is an environmentally conscious product.

### SUMMARY OF THE INVENTION

In accordance with one aspect of the invention, there is provided an apparatus for applying a wax seal to an article such as a bottle comprising a bottom tank formed of at least one upstanding wall and a closed bottom wall and having an open top end, said bottom tank being fitted with suitable electrical heating means, such as a plurality of electrical heating coils; an upper tank formed of at least one upstanding wall and having an open top end and a closed bottom wall, said upper tank being fitted with suitable electrical heating means, such as an electrical heating coil, said upper tank being connected at its bottom end with the open top end of said bottom tank, a screen adjustably located inside the upper tank, pump means located in said bottom tank and extending into the upper tank through an opening in the bottom wall of the upper tank, for conveying molten wax from the bottom tank to the upper tank, and an overflow opening in said upper tank.

Generally, the apparatus of the invention contains two heating coils in the bottom tank; the bottom tank being larger than the upper tank. For best heating, it has been found that the heating coils in the bottom tank should be located near or adjacent the bottom wall of the bottom tank.

The heating means in each tank typically extends across the tank at least half way and is parallel to the bottom wall thereof. Of course, any convenient heating means can be used for purposes of the invention. Generally, it has been found to be convenient to locate the heating means near to or adjacent to the bottom wall in each tank.

An overflow opening is located near the top of the upper tank to enable excess molten wax to flow out of the unit when convenient. An important feature of the invention is a screen in the upper tank which is adjustable up or down depending on the size of the article to be sealed with wax.

In accordance with another aspect of the invention, there is provided a method of forming a wax seal on an article such as a closed bottle filled with its contents and especially forming a wax seal on the neck of a wine bottle in place of a conventional foil seal. The bottle can be closed by a cork or screw cap closure. The method of forming the wax seal in place comprises holding one or more closed, full bottles in an inverted position, dipping the inverted bottle into the upper tank of the apparatus herein described filled with molten wax so that the bottle top touches the screen to immerse the bottle up to its neck, withdrawing the bottle with its neck coated with sufficiently molten wax from the upper tank, holding the bottle over the upper tank for a time sufficient for the wax to set, and removing the bottle with its neck sealed with wax from the tank apparatus. The screen is adjustable and is positioned at the correct location in the upper tank, depending on the size of the article to be sealed with the wax.

When carrying out the method of the invention, the screen can be adjusted to a level such that when the bottle is dipped into the molten wax and when the bottle is in contact with the screen the wax will be at a level appropriate to form a wax seal around the neck of the bottle or around the neck and a portion of the bottle shoulder only.

### BRIEF DESCRIPTION OF DRAWINGS

The invention will be further understood with reference to the accompanying drawings wherein:

FIG. 1 is the front view of a rectangular dipping tank of the invention;

FIG. 2 is a top view of the dipping tank shown in FIG. 1;

FIG. 3 is a left side view of the dipping tank of the present invention; and

FIG. 4 is a right side view of the dipping tank of the invention.

### DETAILED DESCRIPTION OF INVENTION

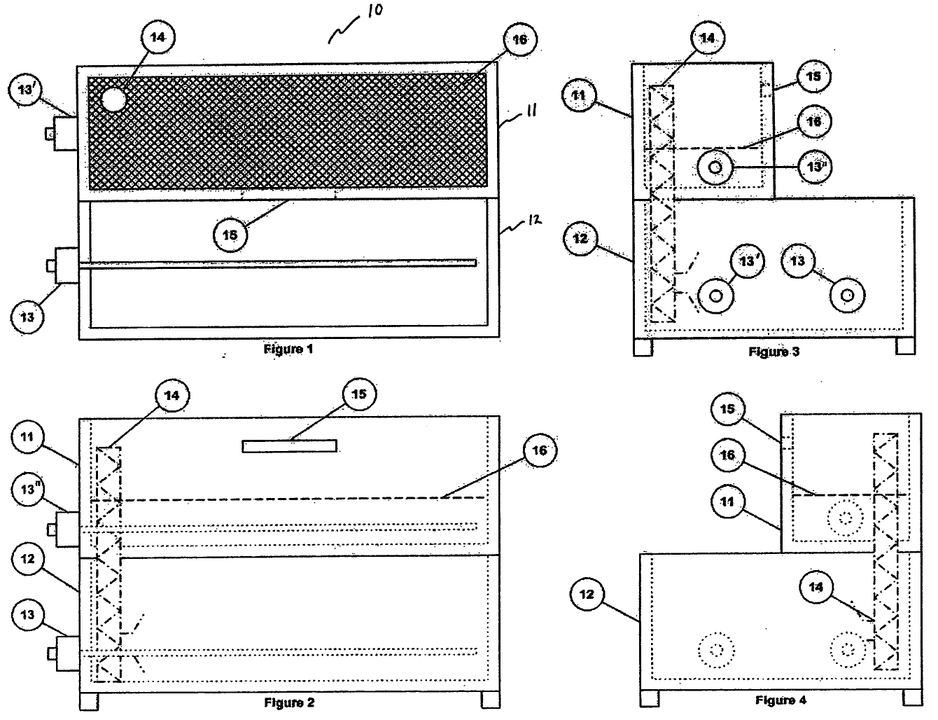

As shown in FIG. 1, the dipping tank apparatus of the present invention 10 is a two-vat system composed of an upper tank 11 and a larger, lower tank 12. The lower tank 12 has a closed bottom wall and an open top. The upper tank 11 has an open top and a closed bottom wall except for an opening for a pump device 14 for pumping molten wax from the bottom tank to the upper tank. Although shown as rectangular tanks, the dipping tank apparatus can be of any convenient size and shape, such as round, square, hexagonal, etc. A plurality of heating coils 13, 13′ are located in the lower tank 12 to melt the wax. The tanks are preferably insulated, both top and bottom, to maintain a consistent wax temperature. The bottom heating coils have the capacity in terms of volts and amps to efficiently bring the wax up to the desired melting temperature. The heating coil 13″ in the upper tank is maintained at a temperature sufficient to hold the wax at the necessary application temperature for applying the molten wax to the desired article, such as the necks of wine bottles for the purpose of sealing the wine bottles. Typically, the wax should be heated to about 275° F. to 300° F. depending on the type of wax employed. The number of heating coils can be varied as convenient. Any suitable heating means can be used for purposes of the invention.

The bottom tank 12 holds the melted wax and a screw conveyor pump 14 or other suitable pump moves the molten wax up to the upper tank 11 where a second heater coil 13″ holds and maintains the molten wax at the necessary application temperature for applying the wax to the intended article, such as a bottle. There is an overflow hole or opening 15 of any convenient size and shape in the top tank which keeps the molten sealing wax in the upper tank at a constant level.

As shown, the upper tank is about one-half the size of the bottom tank, although the proportions of the tanks can be varied.

The upper tank shown in FIG. 1 is offset rearwardly with respect to the front of the bottom tank so that the rear walls of the tanks line up and are flush with each other.

In the upper tank 11 there is located a screen 16 below the surface of the melted wax. The screen which can be made of any suitable metal or heat resistant fabric is for the purpose of allowing the wax to flow through the screen but acts as a stop for article penetration into the tank to provide the necessary depth for bottle dipping. The height of the screen can be adjusted up or down depending upon the size and shape of the article or bottle to be wax sealed. Thus, the screen can be raised or lowered depending upon the size and shape of the article to be coated with the wax. In operation, one would dip one or more of the articles or the inverted bottles into the upper tank until the top of the bottle neck contacts the screen which would be set at a predetermined correct depth which would give the desired wax coverage to the neck of the bottle or to the body of the intended article. Any particular area of an article can be coated with the wax depending on position of the screen.

The overflow opening 15 is set so that when the screen 16 is located at the correct height according to the article to be sealed with the wax, the wax will always be at the correct height in the tank.

The dipping operation can be done by hand or can be mechanized. A single article can be dipped or multiple articles can be dipped at the same time. In actual use, the article is held by hand or by suitable mechanical means and dipped into molten wax contained in the tank according to a predetermined depth. For example, a bottle containing a liquid would be inverted and submerged in the wax for a sufficient distance to immerse the neck portion of the bottle, which distance would be determined by the location and position of the screen. The screen is adjusted every time the size of the article is changed. After a sufficient time of immersion to make certain that a uniform and adequate coating is obtained, the article is then removed from the wax. Upon removal from the upper tank, the bottle is held for a second or two until the wax sets up After cooling, the wax forms a secure and impermeable seal on the bottle and replaces the function of the foil seal presently found on many types of bottles, particularly wine bottles.

A wide variety of articles can be dipped into the dipping tank apparatus of this invention, including whiskey and other spirit bottles, olive oil and vinegar bottles, cheese and the like.

A wide variety of sealing waxes is available on the market for dipping. The waxes are blended and formulated to allow for an even layer of wax to be applied to the desired portion of the article, such as the neck and top of the bottle. The wax is available in a rainbow of colors and is easy for the ultimate consumer to peel off the bottle top at room temperature, as well as under chilled wine serving conditions. Typically, the dipping is done by hand. Suitable waxes are available from SouthWest Wax, LLC and are in compliance with FDA regulations. Sealing waxes are well known in the art and their properties and characteristics are well recognized by persons skilled in the art.

Properties of a typical sealing wax are shown below in the table.

BW-580 Series Wine Bottle Sealing Wax

| Test Description | | Typical |
|---|---|---|
| Congealing Point F (D-938) | | 174° F. |
| Needle Penetration (D1321) | 0.1 mm @ 77° F. | 8 |
| | 0.1 mm @ 100° F. | 18 |

| | |
|---|---|
| Brookfield Viscosity (D3236) cps @ 270° F. | 2850 |

FDA Status: This product is in compliance with Federal Regulation 21 CFR 175.105 and 21 CFR 178.3297

The present invention ensures that each bottle or article of a given size and shape is dipped to the exact same length or height.

The tanks are typically made of stainless steel and the heaters are made to conform to Underwriter Laboratory listing standards. The screw conveyor is of conventional design and should also be made of stainless steel. Any suitable natural or synthetic sealing wax can be used for the sealing wax in accordance with the present invention.

Further variations and modifications of the foregoing will be apparent to those skilled in the art and are intended to be encompassed by the claims appended hereto.

I claim:

1. An apparatus for applying a wax seal to a surface of an article comprising:
a bottom tank formed of at least one upstanding wall and a bottom wall and having an open top end, said bottom tank being fitted with at least one electrical heating means;
an upper tank formed of at least one upstanding wall and having a open top end and a closed bottom wall, said upper tank being fitted with an electrical heating means, said upper tank being connected at its closed bottom wall with the open top end of said bottom tank,
a screen adjustably located inside the upper tank,
pump means located in said bottom tank and extending into the upper tank to be able to convey molten wax from the bottom tank to the upper tank, and
an overflow opening in said upper tank.

2. The apparatus of claim 1 which contains two heating coils as the electrical heating means in the bottom tank.

3. The apparatus of claim 1 wherein the bottom tank is larger than the upper tank.

4. The apparatus of claim 1 wherein the electrical heating means in the bottom tank is located adjacent the bottom wall of the bottom tank.

5. The apparatus of claim 1 wherein the overflow opening is located near the top of the upper tank.

6. The apparatus of claim 1 wherein the screen in the upper tank can be adjusted up or down depending on the size of the article to be sealed with wax.

7. The apparatus of claim 1 which is filled with molten wax.

8. The apparatus of claim 1 wherein each of said upper and lower tanks are rectangular in shape.

9. The apparatus of claim 1 wherein said electrical heating means is a plurality of heating coils in said bottom tank.

10. The apparatus of claim 1 wherein the bottom wall of the upper tank has an opening for accommodating said pump means.

11. The apparatus of claim 1 wherein said pump means extends up into said upper tank through an opening in said screen.

12. The apparatus of claim 1 wherein the upper tank is offset with respect to the lower tank in a direction rearward from front of bottom tank so that a rear wall of said upper tank is flush with a rear wall of said bottom tank.

13. The apparatus of claim 1 wherein said upper tank is approximately one-half size of the bottom tank.

14. The apparatus of claim 1 wherein said heating means extends at least halfway across length of said bottom tank and parallel with its bottom wall.

15. The apparatus of claim 1 wherein said heating means extends at least halfway across length of said upper tank and parallel with its bottom wall.

16. The apparatus of claim 1 wherein said heating means in said upper and bottom tanks extend substantially across length of tank and parallel with the bottom wall of each tank.

17. A method of forming a wax seal on a selected area of an article comprising:
holding the article over an open upper tank filled with molten sealing wax, dipping the article into the upper tank of the apparatus of claim 7 filled with molten wax to a predetermined depth so that the molten wax covers the area intended to be coated with the wax,
withdrawing the article coated with molten wax in a predetermined area from the upper tank,
holding the article over the upper tank for a time sufficient for the wax to set, and
removing the article with said area sealed with wax from the apparatus.

18. The method of claim 17, wherein the article is a bottle

19. The method of claim 18 wherein the bottle is a wine bottle.

20. A method of forming a wax seal on the neck of a bottle comprising:
holding a closed, full bottle in an inverted position,
dipping the bottle into a tank filled with molten sealing wax,
withdrawing the bottle with its neck coated with wax,
holding the bottle over the tank for a time sufficient for the wax to set, and
removing the bottle with its neck sealed with the wax.

21. The method of claim 20 further comprising adjusting a screen in the tank to a level such that when the bottle is dipped into the molten sealing wax and when the bottle is in contact with the screen the wax will be at a level appropriate to form a desired wax seal around the neck of the bottle only.
